(19) United States
(12) Patent Application Publication
(10) Pub. No.: US 2019/0241418 A1
(43) Pub. Date: Aug. 8, 2019

(54) AUTOMOTIVE JACKING ASSEMBLY

(71) Applicant: Carlford Griffin, Plaquemine, LA (US)

(72) Inventor: Carlford Griffin, Plaquemine, LA (US)

(21) Appl. No.: 15/890,833

(22) Filed: Feb. 7, 2018

(51) Int. Cl. B66F 17/00; B66F 3/00

(52) U.S. Cl. CPC B66F 17/00; B66F 3/00

(57) ABSTRACT

An automotive jacking assembly includes a jack that has a crank thereon for lifting and lowering the jack. A receiver is coupled to the crank to insertably receive a ratcheting wrench. A swivel is removably coupled to the receiver such that the swivel is positionable at a selected angle with respect to the crank. A plurality of extensions is provided and each of the extensions is selectively and removably coupled to the swivel. In this way the ratcheting wrench may be spaced from the swivel thereby facilitating a user to be remotely positioned with respect to the jack.

### CROSS-REFERENCE TO RELATED APPLICATIONS

### Statement Regarding Federally Sponsored Research or Development

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to jacking devices and more particularly pertains to a new jacking device for manipulating a jack from an acute angle.

### BRIEF SUMMARY OF THE INVENTION

An embodiment of the disclosure meets the needs presented above by generally comprising a jack that has a crank thereon for lifting and lowering the jack. A receiver is coupled to the crank to insertably receive a ratcheting wrench. A swivel is removably coupled to the receiver such that the swivel is positionable at a selected angle with respect to the crank. A plurality of extensions is provided and each of the extensions is selectively and removably coupled to the swivel. In this way the ratcheting wrench may be spaced from the swivel thereby facilitating a user to be remotely positioned with respect to the jack.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a swivel and a plurality of extensions of an automotive jacking assembly according to an embodiment of the disclosure.

FIG. 2 is a detail view of a receiver and a jack of an embodiment of the disclosure.

FIG. 3 is a perspective view of an embodiment of the disclosure.

FIG. 4 is a perspective in-use view of an embodiment of the disclosure.

### DETAILED DESCRIPTION OF THE INVENTION

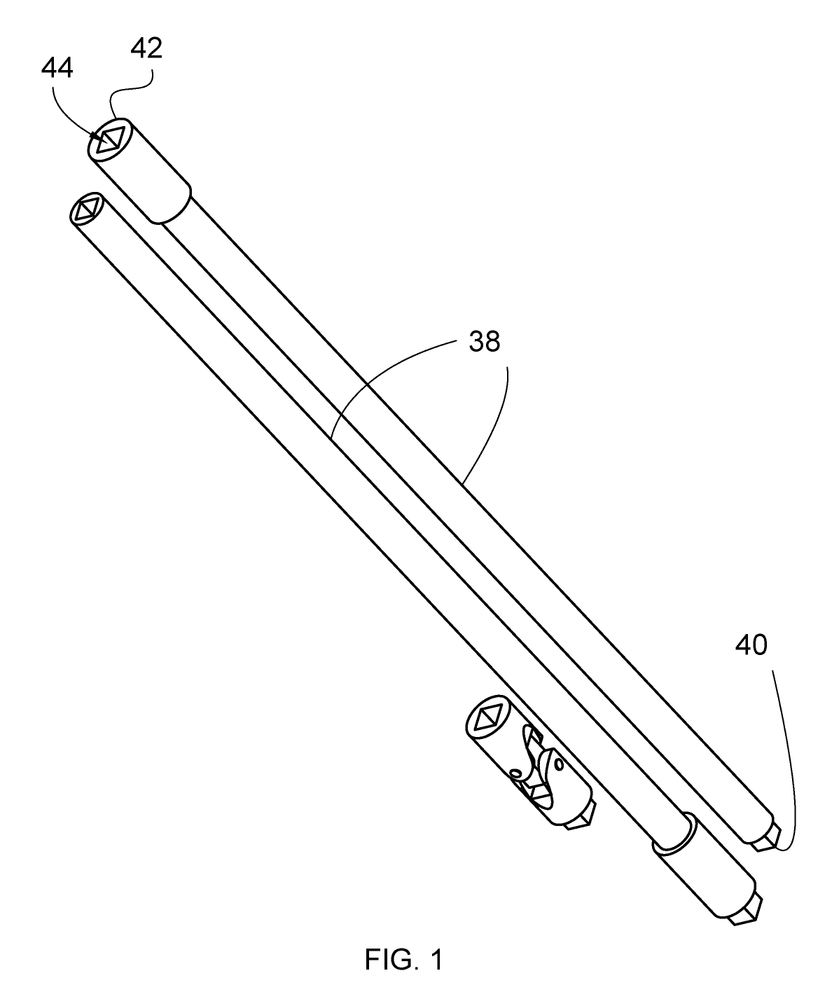

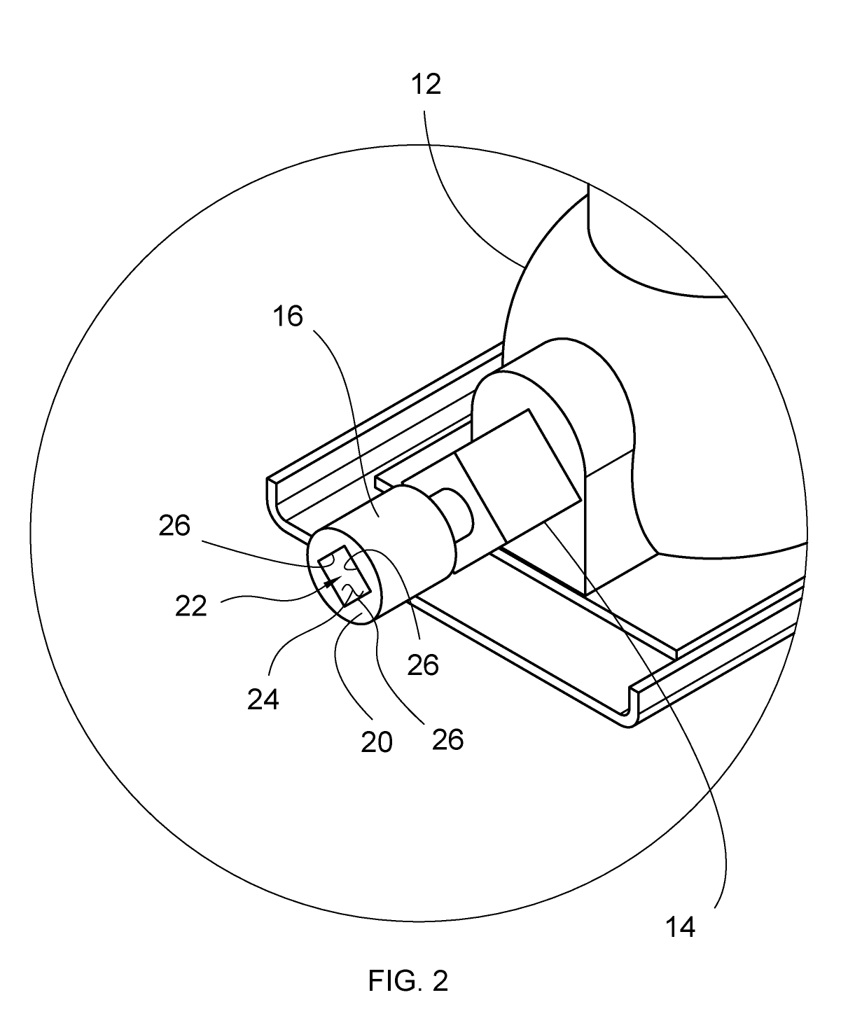

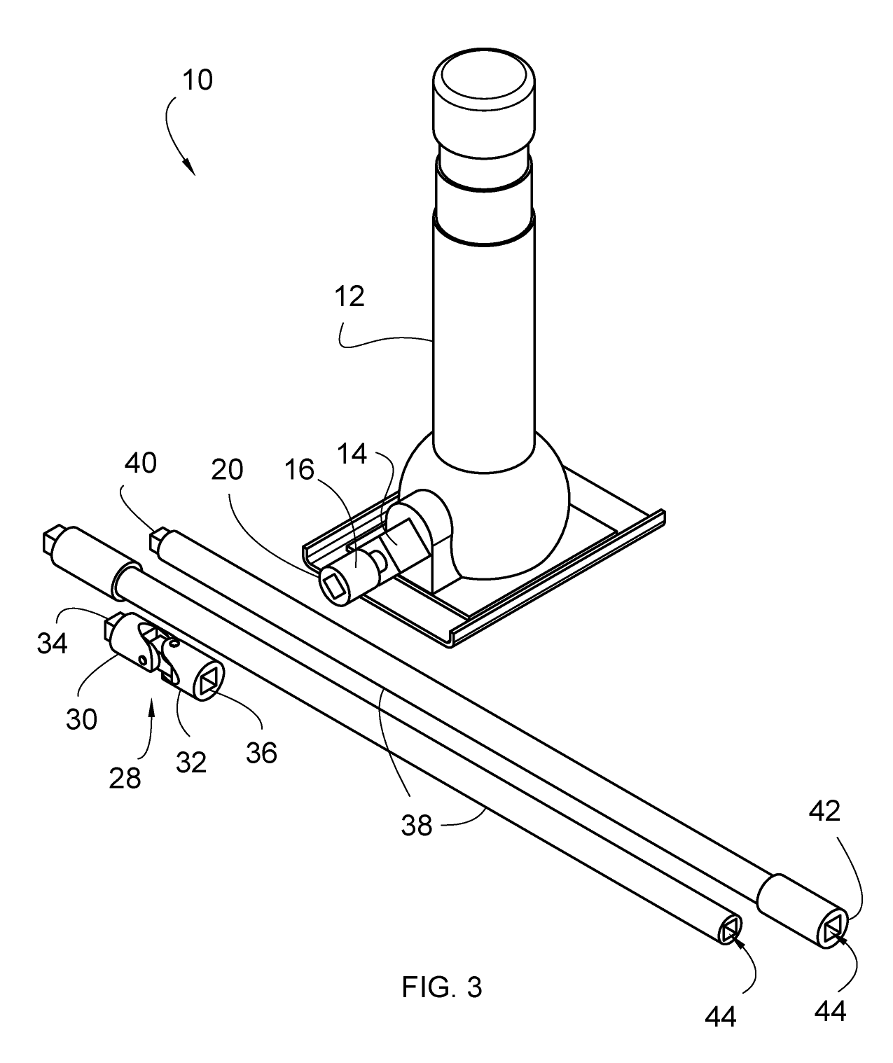

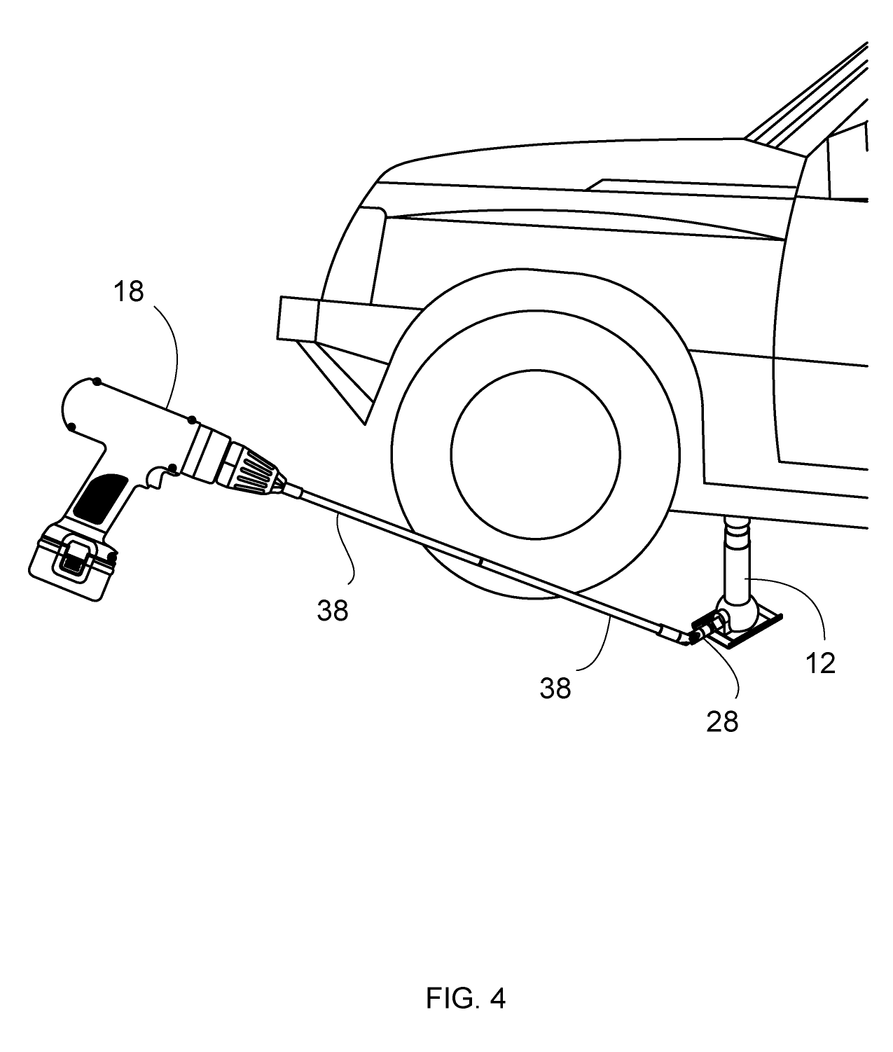

With reference now to the drawings, and in particular to FIGS. 1 through 4 thereof, a new jacking device embodying the principles and concepts of an embodiment of the disclosure and generally designated by the reference numeral 10 will be described.

As best illustrated in FIGS. 1 through 4, the automotive jacking assembly 10 generally comprises a jack 12 that has a crank 14 thereon and the crank 14 is rotatable for lifting and lowering the jack 12. The jack 12 may be a hydraulic vehicle jack, a mechanical scissor vehicle jack and any other type of jack 12 for lifting and lowering a vehicle. The vehicle may be a passenger vehicle or other vehicle that is commonly driven on public roadways. Additionally, the vehicle may be parked on a shoulder of the public roadway when the vehicle gets a flat tire.

A receiver 16 is coupled to the crank 14 for insertably receiving a tool 18 with a squared end, such as a socket wrench, a driver bit for a power drill and any other tool with a squared end. Moreover, the tool 18 with the squared end is specifically any tool other than the elongated rod that is included with the jack 12. The receiver 16 has a distal end 20 with respect to the crank 14 and the distal end 20 has a well 22 extending towards the crank 14. The well 22 has a bounding surface 24 and the bounding surface 24 has a plurality of intersecting sides 26. Moreover, the receiver 16 may be a ⅜ inch socket or the like that has a square female end for receiving the squared end of the tool 18.

A swivel 28 is provided and the swivel 28 is removably coupled to the receiver 16 such that the swivel 28 is positionable at a selected angle with respect to the crank 14. The swivel 28 has a first portion 30 that is pivotally coupled to a second portion 32. The first portion 30 has a male coupler 34 thereon and the second portion 32 has a female coupler 36 thereon. The 22 well in the receiver 16 insertably receives the male coupler 34 for removably coupling the swivel 28 to the receiver 16.

The female coupler 36 insertably receives the tool 18 in a first orientation. Moreover, the tool 18 is oriented at an angle with respect to the crank 14 when the tool 18 is in the first orientation. In this way a user may be positioned next to the vehicle and face oncoming traffic when the jack 12 is lifted and lowered thereby allowing the user to respond to a potential danger with respect to oncoming traffic striking the vehicle. The swivel 28 may be a ⅜ inch socket swivel or the like.

A plurality of extensions 38 is provided and each of the extensions 38 is selectively and removably coupled to the swivel 28. Thus, the extensions 38 space the tool 18 a selectable distance from the swivel 28 thereby facilitating the user to be remotely positioned with respect to the jack 12. Each of the extensions 38 has a first end 40 and a second end 42 and the second end 42 corresponding to each of the extensions 38 has a well 44 extending towards the first end 40 of the corresponding extension 38. The female coupler 36 on the swivel 28 insertably receives the first end 40 of the selected extension 38.

The well 44 in the second end 42 of the extension 38 that is coupled to the swivel 28 insertably receives the first end 40 of one of the extensions 38. In this way the extensions 38 are coupled together to position the tool 18 in a second orientation. Moreover, the tool 18 is a spaced a selectable distance from the jack 12 when the tool 18 is in the second orientation. Each of the extensions 38 may be 6.0 inch long, ⅜ socket extensions 38 or the like.

In use, the jack 12 is positioned beneath the vehicle and the tool 18 is positioned in the receiver 16 for lifting the jack 12. The receiver 16 allows the jack 12 to be lifted and lowered without using the elongated rod that is commonly provided with jacks. Thus, the elongated rod does not extend out into the roadway when the jack 12 is being lifted, potentially exposing the elongated rod to the danger of being driven over by the oncoming traffic. The swivel 28 is selectively coupled to the receiver 16 to allow the tool 18 to be positioned at an angle with respect to the jack 12. In this way the user may face the oncoming traffic, rather than having their back facing oncoming traffic when using the conventional, elongated rod, while the jack 12 is being lifted and lowered. Additionally, the extensions 38 are selectively positioned between the swivel 28 and the receiver 16 thereby allowing the user to move away from the jack 12 when the jack 12 is being lifted and lowered.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An automotive jacking assembly being configured to lift a vehicle adjacent to a roadway without placing a user in said line of traffic, said assembly comprising:
a jack having a crank thereon wherein said crank being configured to be rotatable for lifting and lowering said jack;
a receiver being coupled to said crank wherein said receiver being configured to insertably receive a tool for rotating said crank;
a swivel being removably coupled to said receiver such that said swivel being positionable at a selected angle with respect to said crank; and
a plurality of extensions, each of said extensions being selectively and removably coupled to said swivel wherein said extensions are configured to space said ratcheting wrench from said swivel thereby facilitating a user to be remotely positioned with respect to said jack.

2. The assembly according to claim 1, wherein said receiver has a distal end with respect to said crank, said distal end having a well extending towards said crank, said well having a bounding surface, said bounding surface having a plurality of intersecting sides.

3. The assembly according to claim 2, wherein said swivel has a first portion being pivotally coupled to a second portion, said first portion having a male coupler thereon, said second portion having a female coupler thereon wherein said female coupler is configured to insertably receive said ratcheting wrench in a first orientation thereby facilitating said ratcheting wrench to be oriented at an angle with respect to said crank when said jack being lifted and lowered.

4. The assembly according to claim 3, wherein said well in said receiver insertably receives said male coupler for removably coupling said swivel to said receiver.

5. The assembly according to claim 3, wherein each of said extensions has a first end and a second end, said second end corresponding to each of said extensions having a well extending towards said first end of said corresponding extension.

6. The assembly according to claim 5, wherein said female coupler on said swivel insertably receives said first end of said selected extension, said well in said second end of said extension that is coupled to said swivel insertably receiving said first end of one of said extensions wherein said extensions are configured to space said ratcheting wrench in a second orientation being a selectable distance from said jack.

7. An automotive jacking assembly being configured to lift a vehicle adjacent to a roadway without placing a user in said line of traffic, said assembly comprising:
a jack having a crank thereon wherein said crank being configured to be rotatable for lifting and lowering said jack;
a receiver being coupled to said crank wherein said receiver being configured to insertably receive a ratcheting wrench, said receiver having a distal end with respect to said crank, said distal end having a well extending towards said crank, said well having a bounding surface, said bounding surface having a plurality of intersecting sides;
a swivel being removably coupled to said receiver such that said swivel being positionable at a selected angle with respect to said crank, said swivel having a first portion being pivotally coupled to a second portion, said first portion having a male coupler thereon, said second portion having a female coupler thereon wherein said female coupler being configured to insertably receive said ratcheting wrench in a first orientation thereby facilitating said ratcheting wrench to be oriented at an angle with respect to said crank when said jack being lifted and lowered, said well in said receiver insertably receiving said male coupler for removably coupling said swivel to said receiver; and
a plurality of extensions, each of said extensions being selectively and removably coupled to said swivel wherein said extensions are configured to space said ratcheting wrench from said swivel thereby facilitating a user to be remotely positioned with respect to said jack, each of said extensions having a first end and a second end, said second end corresponding to each of said extensions having a well extending towards said first end of said corresponding extension, said female coupler on said swivel insertably receiving said first end of said selected extension, said well in said second end of said extension that is coupled to said swivel insertably receiving said first end of one of said extensions wherein said extensions are configured to space said ratcheting wrench in a second orientation being a selectable distance from said jack.
